(19) United States
(12) Patent Application Publication
(10) Pub. No.: US 2026/0068868 A1
(43) Pub. Date: Mar. 12, 2026

(54) PEST CONTROL DEVICE

(71) Applicant: Jack W. Hooks, Mansfield, OH (US)

(72) Inventor: Jack W. Hooks, Mansfield, OH (US)

(21) Appl. No.: 19/327,293

(22) Filed: Sep. 12, 2025

Related U.S. Application Data
(60) Provisional application No. 63/693,744, filed on Sep. 12, 2024.

(51) Int. Cl. A01M 7/00

(52) U.S. Cl. CPC A01M 7/0046; A01M 2200/01

(57) ABSTRACT

A pest control device for dispensing a pest control material is disclosed. The pest control device can include a pneumatic coupling, a tube, and a chamber fluidly coupling the pneumatic coupling and the tube. A screen can be disposed adjacent to the pneumatic coupling, and the screen can militate against the pest control material from entering the pneumatic coupling. The pest control device can include a pneumatic air trigger coupled to the pneumatic coupling, and the chamber can include a removable cap disposed opposite the pneumatic coupling. The pest control device can deliver localized, controlled, and relatively precise amounts of the pest control material from a predetermined distance without the use of a ladder or by having to resort to invasive or destructive methods to access concealed, elevated, or otherwise difficult-to-reach areas.

### CROSS-REFERENCE TO RELATED APPLICATIONS

This application claims the benefit of U.S. Provisional Application No. 63/693,744, filed on Sep. 12, 2024. The entire disclosure of the above application is incorporated herein by reference.

### FIELD

The present technology relates to a dispenser for a powdered or a granular product and, more particularly, to a pest control device for dispensing a pest control material.

### INTRODUCTION

This section provides background information related to the present disclosure which is not necessarily prior art.

Tools for delivering a pest control material, such as insecticide dust, can be used to control and militate against damage caused by various pests, including bees, wasps, ants, rodents, and the like. Pest control tools that apply a pest control material as a dust, also referred to as dusters, can be used to apply various types of pest control materials formulated for various pests. Various types and sizes of dusters can be employed depending on the intended application, including hand dusters and power dusters.

Hand dusters include small, handheld devices designed with a chamber for holding dust and a nozzle or spout for application. Hand dusters can be used in applying dust in cracks, crevices, and other easily accessible tight spaces. The two types of hand dusters include the bulb duster and the bellows duster. The bulb duster features a rubber bulb that the user squeezes to dispense the dust, making it simple and effective for small tasks. The bellows duster, which uses a bellows mechanism to propel dust, is often larger and can hold more dust than the bulb duster.

Power dusters, on the other hand, are more advanced devices that can be battery-powered or electric. They are designed to apply dust over larger areas or at greater heights. Power dusters can offer faster dust application and reduced labor compared to manual hand dusters.

Depending on duster design and pest location, dusters may require the operator to be in close proximity to the area where the pest control material needs to be applied. This can necessitate the use of a ladder to reach high or difficult locations in which the pests or suspected pests reside. In cases where a pest nest is not visible, the pest control professional can apply the material blindly, with no guarantee that it will reach the intended target. If access to the nest is particularly challenging, it may even be necessary to remove part of the wall to reach the pest nest. Being in close proximity with the pest nest can potentially result in the user undesirably coming into contact with the pest. Certain dusters can accordingly lack the versatility to effectively distribute the pest control material in certain pest control situations and may be limited in the ability to provide one or more customized applications of the pest control material.

Accordingly, there is a need for a pest control device that can deliver localized, controlled, and relatively precise amounts of a pest control material from a predetermined distance without the use of a ladder or by having to resort to invasive or destructive methods.

### SUMMARY

In concordance with the instant disclosure, a pest control device that can deliver localized, controlled, and relatively precise amounts of a pest control material from a predetermined distance without the use of a ladder or by having to resort to invasive or destructive methods, has surprisingly been discovered. The present technology includes articles of manufacture and processes that relate to a pest control device for dispensing a pest control material such as a powdered or a granular product.

In certain embodiments, a pest control device for dispensing a pest control material is provided that can include a pneumatic coupling, a tube, and a chamber fluidly coupling the pneumatic coupling and the tube. The chamber can be configured to hold the pest control material. A screen can be disposed adjacent to the pneumatic coupling, and the screen can be configured to militate against the pest control material from entering the pneumatic coupling. An air deflector can be disposed adjacent to the screen.

In certain embodiments, a method of treating an area infested with pests is provided that can employ a pest control device as described herein. The method can include dispensing a fluid through the pneumatic coupling to direct the pest control material out of the tube and into the area infested with pests.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top perspective view of a pest control device coupled to a pneumatic trigger, according to an embodiment of the present disclosure;

FIG. 2 is a right-side elevational view of the pest control device coupled to the pneumatic trigger, according to the embodiment shown in FIG. 1;

FIG. 3 is an exploded top perspective view of the pest control device, according to the embodiment shown in FIG. 1;

FIG. 4 is a right-side elevational view of another pest control device including a spacer coupled to a pneumatic trigger, according to an embodiment of the present dislosure;

FIG. 5 is a right-side elevational view of yet another pest control device including a nozzle, according to an embodiment of the present disclosure;

FIG. 6 is a top perspective view of a user treating an area infested with pests with the pest control device, according to the embodiment shown in FIG. 4; and

FIG. 7 is a flow chart illustrating a method of treating an area infested with pests, according to an embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

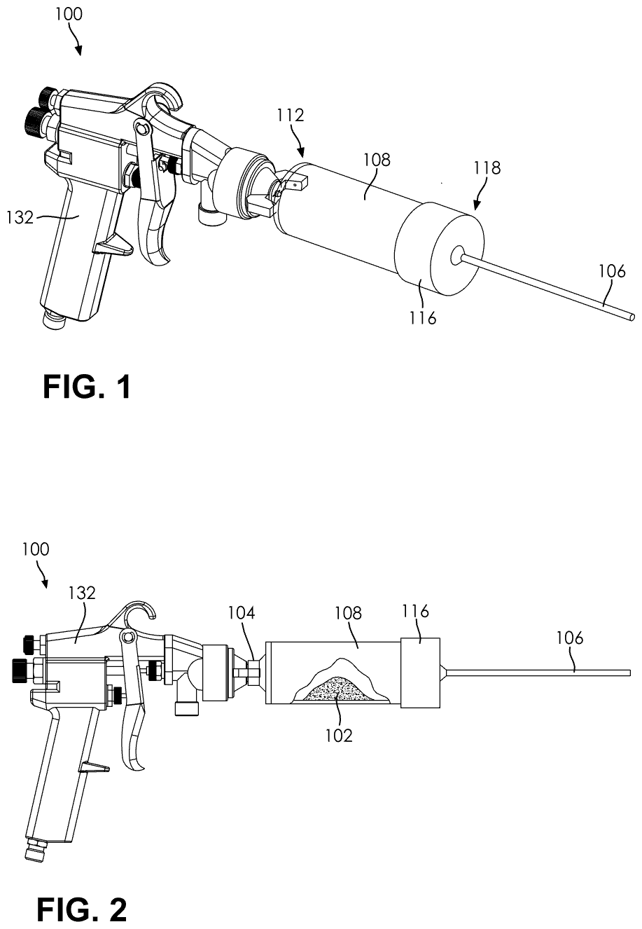

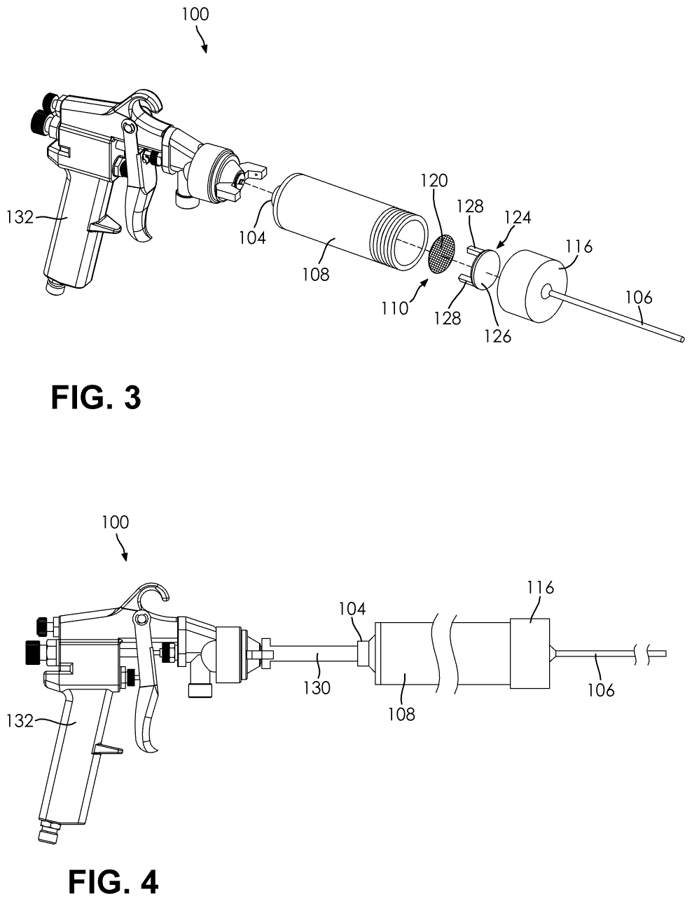

As illustrated in FIGS. 1-6, the present technology provides a pest control device 100 for dispensing a pest control material 102 in a powdered or a granular form. The pest control material 102 can include any suitable insecticide, herbicide, rodenticide, or fungicide known in the art, including naturally derived, synthetic, or biologically based agents, and can include single active agents or combinations thereof. For example, the insecticide can include permethrin, cyfluthrin, imidacloprid, or chlorpyrifos; the herbicide can include glyphosate, atrazine, or 2,4-dichlorophenoxyacetic acid (2,4-D); the rodenticide can include brodifacoum, bromethalin, or zinc phosphide; and the fungicide can include tebuconazole, propiconazole, azoxystrobin, or copper hydroxide. One having ordinary skill in the art can select a suitable pest control material 102 within the scope of the present disclosure.

The pest control device 100 can deliver localized, controlled, and relatively precise amounts of the pest control material 102 from a predetermined distance without the use of a ladder or by having to resort to invasive or destructive methods to access concealed, elevated, or otherwise difficult-to-reach areas. The present technology also provides a method 200 of treating an area 202 infested with pests.

Referring to FIGS. 1-5, aspects of the pest control device 100 are illustrated. The pest control device 100 can include a pneumatic coupling 104, a tube 106, a chamber 108, and a screen 110. In certain embodiments, the pneumatic coupling 104 can be disposed adjacent to a proximal end 112 of the chamber 108 and can be arranged in substantial coaxial alignment with the chamber 108. The pneumatic coupling 104 can include a quick-connect fitting configured to facilitate coupling of the pest control device 100 to a fluid source 114, such as a compressed air tank. For example, the pneumatic coupling 104 can include a push-to-connect or a push-in fitting, such as those available from Parker, SMC, or Festo, an industrial interchange coupler including ISO 6150 B-style or ARO-style couplers, Detroit-style or Snap-Tite couplers, and Nitto or Camlock lever-lock type couplings for rapid engagement. Alternatively, in certain embodiments, the pneumatic coupling 104 can include a hose barb quick-disconnect configured for push-on tubing with integrated valves, as well as a quick-disconnect swivel fitting allowing 360° rotation to militate against hose twisting. One having ordinary skill in the art can select a suitable pneumatic coupling 104 within the scope of the present disclosure.

The chamber 108 can fluidly couple the pneumatic coupling 104 and the tube 106. The chamber 108 can also be configured to hold the pest control material 102, thereby serving as both a fluid conduit and a material reservoir. The chamber 108 can be formed as a cylinder, which can provide manufacturing simplicity and efficient internal volume utilization. Without being held to theory, a cylindrical configuration can also facilitate predictable flow dynamics of a fluid between the pneumatic coupling 104 and the tube 106, thereby enhancing pest control material 102 delivery. Although the chamber 108 can be cylindrical, the chamber 108 is not limited to this shape. In certain embodiments, the chamber 108 can be formed in alternative geometries, such as rectangular, polygonal, or other cross-sections, depending on desired considerations. One having ordinary skill in the art can select a suitable geometry of the chamber 108.

The chamber 108 can include a removable cap 116 positioned at a distal end 118 of the chamber 108, opposite the pneumatic coupling 104. The removable cap 116 can provide access to the interior of the chamber 108, thereby allowing the chamber 108 to be filled, refilled, or cleaned as needed. In certain embodiments, the removable cap 116 can include an interior surface having a frustoconical shape. The frustoconical interior surface can work in concert with the fluid source to enhance material flow through the tube 106. In particular, the interior frustoconical geometry can create a Venturi-like effect that can accelerate the flow of air or other carrier fluid, thereby drawing the pest control material from the chamber 108 into the tube 106 with increased efficiency. This effect can promote consistent dosing and militate against the likelihood of clogging or incomplete material delivery. Although the interior surface of the removable cap 116 can include a frustoconical shape, other interior geometries can be used to achieve similar flow-enhancing characteristics. For example, the interior of the removable cap 116 can include a tapered cylindrical surface, a stepped conical surface, or a multi-angled contour that can likewise promote a Venturi-like effect within the chamber 108.

The removable cap 116 can be coupled to the chamber 108 by a variety of connection mechanisms. For example, the removable cap 116 can be coupled by a threaded connection, a snap-fit connection, a latch or clip, a cam lock, or a quarter-turn fastener. Each of these coupling mechanisms can provide a secure yet releasable engagement that can enable the removable cap 116 to be removed for filling, refilling, or cleaning of the chamber 108. The selection of the coupling mechanism can depend on factors such as ease of use, manufacturing cost, sealing performance, or the intended operating environment of the pest control device.

In certain embodiments, the removable cap 116 and the tube 106 can be integrally formed with one another. Alternatively, the removable cap 116 and the tube 106 can be removably coupled to one another. This can allow the tube 106 to be detached from the removable cap 116 for cleaning, replacement, or extension. The removable cap 116 and the tube 106 can be removably coupled using a connection mechanism selected from a threaded connection, a snap-fit connection, a latch or clip, a cam lock, or a quarter-turn fastener. Each of these coupling mechanisms can provide a secure yet releasable engagement between the removable cap 116 and the tube 106, enabling convenient assembly and disassembly while maintaining an effective seal during operation.

In certain embodiments, the pest control device 100 can include the screen 110 disposed upstream of the pneumatic coupling 104. The screen 110 can be adjacent the pneumatic coupling 104 to allow for a majority of the volume of the chamber 108 to accommodate the pest control material 102 and for mixing of the pest control material 102 with the fluid introduced from the pneumatic coupling 104. The screen 110 can be configured to militate against the pest control material 102 from entering the pneumatic coupling 104, while still allowing passage of a fluid, such as air, compressed air, vapor, or CO₂. In certain embodiments, the screen 110 can include a plurality of apertures configured to provide fluid communication between the pneumatic coupling 104 and the tube 106 while inhibiting solid or particulate pest control material 102 from migrating through the pneumatic coupling 104. Each aperture can have a circular shape, thereby offering uniform structural strength and a consistent flow path for fluid transfer. The apertures can include a circular shape, an oval shape, a rectangular shape, a square shape, and a hexagonal shape. Different geometries of apertures can be used to optimize fluid flow and minimize clogging. For example, circular apertures can resist material buildup and facilitate ease of manufacture, while hexagonal or rectangular apertures can increase open area and thereby improve fluid flow. The apertures can be distributed across the screen 110 in a uniform or non-uniform pattern depending on the application. The screen 110 can be fabricated from a metallic, polymeric, or composite material to provide durability under environmental conditions such as exposure to the pest control chemical 102, fluctuating temperatures, or moisture. In certain embodiments, the dimensions of the apertures and the thickness of the screen 110 can be selected to balance fluid permeability with mechanical strength. The screen 110 can militate pest control material 102 from entering the pneumatic coupling 104 when the distal end 112 of the chamber 108 is positioned above horizontal, including where the pest control device 100 pointed upwards at various angles up toward a completely vertical position. In this way, the pest control material 102 is retained in the chamber 108 and cannot exit the pneumatic coupling 104.

In certain embodiments, the screen 110 can include a mesh 120 configured to militate against the pest control material 102 from entering the pneumatic coupling 104 while permitting the passage of a fluid. The mesh 120 can provide a balance between strength and permeability, enabling controlled fluid transfer while militating against undesired migration of the pest control material 102 into the pneumatic coupling 104 and the fluid source. In certain embodiments, the mesh 120 can include a woven wire mesh and a knitted wire mesh. The mesh 120 can include a metal, a metal alloy, a polymer, a composite material, and combinations thereof. For example, stainless steel wire mesh can be used to provide corrosion resistance and mechanical strength, while polymeric mesh can be employed to reduce cost and weight or to resist chemical degradation from certain pest control materials. Composite or hybrid meshes may combine the benefits of multiple materials, such as the durability of metal with the flexibility of polymers. In certain embodiments, the mesh 120 can include a mesh size in a range of 1 mesh to 1,000 mesh, allowing the design to be tuned to the desired level of filtration and fluid throughput while taking into consideration the granular characteristics of the pest control material 102. Coarser mesh sizes may be used in applications requiring high airflow with minimal restriction, while finer mesh sizes may be advantageous in militating against small particulates of the pest control material 102 from reaching or exiting the pneumatic coupling 104.

In certain embodiments, the tube 106 can be bendable or flexible to facilitate delivery of the pest control material 102 into areas that are otherwise difficult to access. For example, the tube 106 can be directed into crevices, wall voids, crawl spaces, or other confined regions where pests reside. The flexibility of the tube 106 can enable the user to navigate around obstructions, reach behind equipment, and dispense the pest control material 102 at various angles and curves without repositioning the entire pest control device 100. In this way, the tube 106 can be conformed to negotiate an obstacle without having to account for the remainder of the pest control device 100, including the size and shape of the chamber 108. The tube 106 can include any suitable material or combination of materials that provide both structural integrity and flexibility, including polymers, elastomers, composites, or flexible metal alloys. The tube 106 can be configured to retain a pre-determined shape once positioned by the user, thereby allowing the tube 106 to hold a desired orientation during dispensing. For example, at least a portion of the tube 106 can include an aluminum alloy that can be conformed to a predetermined shape, curve, or angle, and that can retain the shape, curve, or angle in use when the pressurized fluid is dispensing the pest control material 102 from the tube 106. It should be understood that the tube 106 can be provided in different lengths. A shorter tube 106 can be used where a compact form is desired, while a longer tube 106 can be advantageous for reaching confined, elevated, or otherwise difficult-to-access areas.

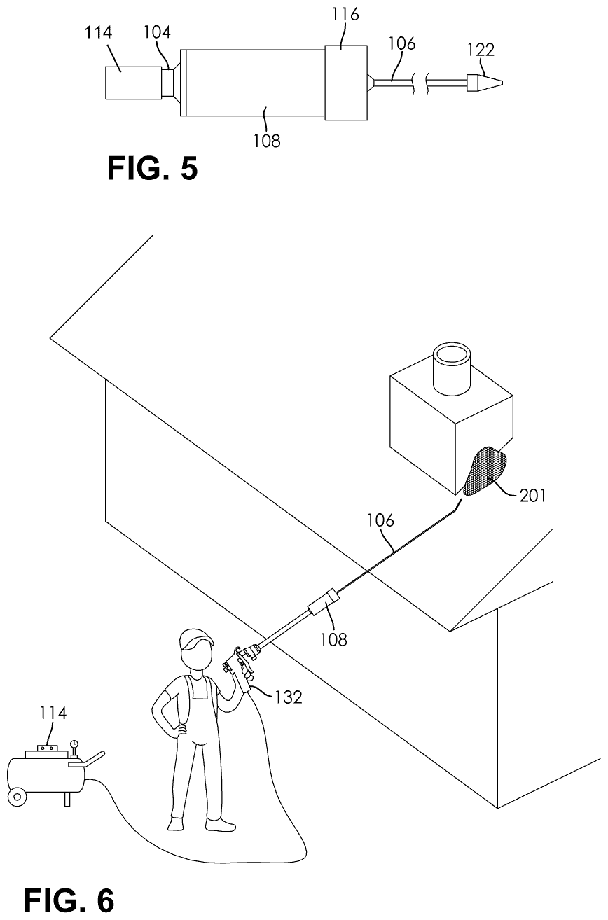

As shown in the embodiment depicted in FIG. 5, the tube 106 can include a nozzle 122 configured to direct and control the flow of the pest control material 102 as it is dispensed from the pest control device 100. The nozzle 122 can regulate a discharge pattern, velocity, and/or distribution of the pest control material 102. For example, the nozzle 122 can include a tapered or converging section to increase exit velocity, thereby enhancing the ability of the pest control material 102 to be propelled toward a target surface or into a void. Alternatively, the nozzle 122 can include a diverging or fan-shaped outlet to produce a broader distribution pattern for covering larger areas. The nozzle 122 can be fabricated from any suitable material, including metals, polymers, or composites, and may be configured to resist abrasion from granular materials. The nozzle 122 can be removably coupled to the tube 106 to permit interchangeability of nozzle types, cleaning, or replacement. One of ordinary skill in the art will appreciate that selection of nozzle size, shape, and material can be made based on the desired application environment, pest control material 102 formulation, and material delivery requirements.

In certain embodiments, the chamber 108 can include an air deflector 124 configured to influence the movement of the fluid and the pest control material 102 within the chamber 108. The air deflector 124 can be positioned and shaped to redirect fluid flow and promote fluidization and flow of the pest control material 102 through the tube 106. The air deflector 124 can militate against the likelihood of clogging, militate against excessive accumulation of material in localized regions of the chamber 108, and improve dispensing of the pest control material 102. The air deflector 124 can include a disk 126 having a plurality of legs 128. The disk 126 can include a substantially planar or slightly curved surface oriented transverse to the fluid flow path, while the plurality of legs 128 can extend radially or axially to couple the disk 126 to an interior wall of the chamber 108. The disk 126 can have a diameter less than a diameter of the chamber 108 such that the fluid entering from the pneumatic coupling 104 can pass through the screen 110 (where present) and around the edge of the disk 126 to interact with the pest control material 102 in the chamber 108.

In certain embodiments, the air deflector 124 can be disposed adjacent the screen 110, thereby providing a barrier that can further militate against pest control material 102 entering the pneumatic coupling 104. Alternatively, the air deflector 124 can be disposed adjacent the removable cap 116 of the chamber 108. Position and arrangement of the air deflector 124 can promote circulation of air toward the inlet region of the chamber 108, thereby preventing material from compacting near the removable cap 116 and ensuring that pest control material 102 remains in a fluidized, flowable state. The air deflector 124 can be disposed substantially at a longitudinal center of the chamber 108, thereby optimizing pest control material 102 distribution and reducing dead zones where pest control material 102 might otherwise settle or compact. The air deflector 124 can further operate to introduce one or more vortices in movement of the fluid from the pneumatic coupling 104 through the chamber 108 to the tube 106. The one or more vortices can facilitate fluidizing of the pest control material 102 for dispensing and can further ensure the entirety of the pest control material 102 is dispensed from the chamber 108, if desired.

In certain embodiments, the pest control device 100 can include a fluid source 114 to generate a motive force for dispensing the pest control material 102 from the chamber 108 through the tube 106. The fluid source 114 can include a gas or a mixture of gas and liquid, depending on the intended application and type of pest control material 102 being dispensed. A suitable gas can include air, compressed air, and carbon dioxide (CO₂). For example, compressed air can be supplied to the pneumatic coupling to fluidize and transport powdered pest control material 102 through the tube 106. Alternatively, the fluid source 114 can include a liquid, such as water or an aqueous solution, which can be directed into the chamber 108 to entrain or dissolve the pest control material 102 prior to dispensing. A mixture of a gas and a liquid can be used, where the gas-liquid mixture can create a foam or mist for distribution of the pest control material 102.

In certain embodiments, the fluid source 114 can be integrated into the pest control device 100. For example, the pest control device 100 can include an onboard compressed air canister, pressurized CO₂ cartridge, or liquid reservoir fluidly coupled to the pneumatic coupling or to the chamber 108. This configuration can allow the pest control device 100 to be portable and self-contained for use in field applications. Alternatively, the fluid source 114 can be external to the pest control device 100. For example, the pneumatic coupling 104 can be configured to connect to an external air compressor, a CO₂ tank, or a pressurized liquid line. An external fluid source can provide extended operational capacity, reduced refilling frequency, or increased dispensing pressure compared to integrated sources.

As shown in FIG. 5, the pest control device 100 can include an extension 130 configured to increase a longitudinal length of either the pneumatic coupling 104. The extension 130 can be used to adapt the pest control device 100 for applications requiring greater reach or access to confined or elevated areas. For example, the extension 130 can allow the user to dispense pest control material 102 into wall cavities, attics, crawlspaces, or other locations that can otherwise be difficult to access. The extension can be removably coupled to the pneumatic coupling 104. A removable coupling can include any suitable connection mechanism known in the art. For example, the suitable connection mechanism can include a threaded connection, snap-fit, latch, clip, bayonet connection, cam lock, or quarter-turn fastener. This configuration can permit the user to selectively add or remove the extension depending on the operational requirements of the application. Additionally, the extension 130 can include a plurality of extensions that can be coupled together in series to progressively increase the overall length of the pest control device 100. For example, multiple extensions 130 can be connected end-to-end to create a variable-length pest control device 100.

In certain embodiments, the pest control device 100 can include a pneumatic trigger 132 for selectively controlling the flow of fluid from the fluid source 114, such as compressed air. The pneumatic trigger 132 can be configured as a manually actuatable valve, for example a lever, button, or squeeze handle, operatively coupled to the pneumatic coupling 104 of the pest control device 100. When actuated, the pneumatic trigger 132 can permit fluid flow from the fluid source 114 into the chamber 108, and when released, the pneumatic trigger 132 can restrict or terminate fluid flow. This controlled delivery of fluid can enable selective dispensing of pest control material 122 from the chamber 108 through the tube 106. The pneumatic trigger 132 can be biased toward a closed position by a biasing element, such as a spring, elastic member, or pneumatic return system, such that fluid flow automatically ceases when the pneumatic trigger 132 is not engaged. The pneumatic trigger 132 can include a locking mechanism that allows the pneumatic trigger 132 to remain in an open position, thereby maintaining continuous fluid flow until released by the user. The pneumatic trigger 132 can be integrated directly into the pneumatic coupling 104 or can be disposed in fluid communication with the pneumatic coupling 104 through an intermediate conduit. The pneumatic trigger 132 can also include flow-modulating features, such as adjustable orifices, variable valves, or regulators, to enable adjustment of fluid flow rate and pressure.

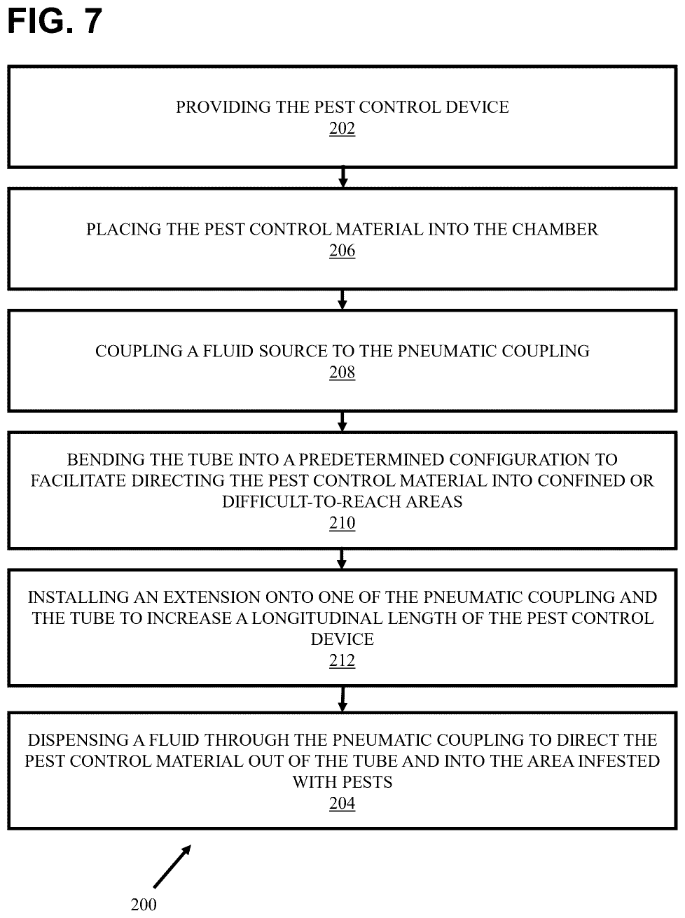

Referring to FIG. 7, a method 200 of treating an area infested with pests is illustrated. The method 200 can include a sequence of steps for preparing and operating the pest control device 100 to dispense a pest control material 102 into the target area. In step 202, the method 200 can include providing the pest control device 100 as described herein. In step 204, the method 200 can include dispensing a fluid through the pneumatic coupling 104 to direct the pest control material 102 out of the tube 106 and into the area infested with pests. The fluid can include a gas, such as compressed air or carbon dioxide, a liquid, or a mixture thereof. In certain embodiments, the dispensing of the fluid can be selectively controlled by a pneumatic trigger 132, thereby allowing a user to regulate the timing and duration of pest control material 102 delivery.

Various alternative operations can occur independently, prior to, or in conjunction with the dispensing in step 204. As shown, in step 206, the method 200 can include placing the pest control material 102 into the chamber 108. Placement of the pest control material 102 can be achieved by removing the removable cap 116 from the chamber 108, inserting the pest control material 102, and then coupling the removable cap 116. In step 208, the method 200 can include coupling a fluid source 114 to the pneumatic coupling 104. The fluid source 114 can be an integrated or external source of compressed air, carbon dioxide, or other fluid suitable for propelling the pest control material 102. In step 210, the method 200 can include bending the tube 106 into a predetermined configuration to facilitate directing the pest control material 102 into confined or difficult-to-reach areas. In step 212, the method 200 can include installing an extension 130 onto one of the pneumatic coupling 104 and the tube 106 to increase a longitudinal length of the pest control device 100. The extension 130 can allow a user to dispense the pest control material 102 into elevated, recessed, or otherwise inaccessible locations.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A pest control device for dispensing a pest control material, comprising:
a pneumatic coupling;
a tube;
a chamber fluidly coupling the pneumatic coupling and the tube, the chamber configured to hold the pest control material; and
a screen disposed adjacent the pneumatic coupling, the screen configured to militate against the pest control material from entering the pneumatic coupling.

2. The pest control device of claim 1, further comprising a pneumatic air trigger coupled to the pneumatic coupling.

3. The pest control device of claim 1, wherein the chamber includes a removable cap disposed opposite the pneumatic coupling.

4. The pest control device of claim 3, wherein the removable cap includes a frustoconical portion.

5. The pest control device of claim 4, wherein the tube is coupled to the removable cap.

6. The pest control device of claim 1, wherein the screen includes a mesh.

7. The pest control device of claim 6, wherein the mesh comprises a material selected from a group consisting of a metal, a metal alloy, a polymer, a composite material, and combinations thereof.

8. The pest control device of claim 6, wherein the mesh includes a mesh size in a range of 1 mesh to 1000 mesh.

9. The pest control device of claim 1, wherein the tube is comprised by a plurality of tubes, each tube having a different length.

10. The pest control device of claim 1, wherein the chamber includes an air deflector.

11. The pest control device of claim 10, wherein the air deflector is disposed adjacent the screen.

12. The pest control device of claim 10, wherein the air deflector includes a disk and a plurality of legs.

13. The pest control device of claim 1, further comprising a fluid source coupled to the pneumatic coupling.

14. The pest control device of claim 13, wherein the fluid source is external to the pest control device.

15. The pest control device of claim 1, further comprising an extension to increase a longitudinal length of the pneumatic coupling.

16. The pest control device of claim 15, wherein the extension is removably coupled to the pneumatic coupling.

17. The pest control device of claim 15, wherein the extension is comprised by a plurality of extensions, each extension having a different length.

18. A pest control device for dispensing a pest control material, comprising:
a pneumatic coupling;
a tube;
a chamber fluidly coupling the pneumatic coupling and the tube, the chamber configured to hold the pest control material;
a removable cap disposed opposite the pneumatic coupling;
a screen disposed adjacent the pneumatic coupling to militate against the pest control material from entering the pneumatic coupling; and
an air deflector disposed adjacent the screen.

19. A method of using a pest control device, the method comprising:
dispensing a pest control material using the pest control device according to claim 1.

20. A method of treating an area infested with pests, the method comprising:
providing a pest control device including
a pneumatic coupling,
a tube, and
a chamber fluidly coupling the pneumatic coupling and the tube, the chamber including a pest control material; and
dispensing a fluid through the pneumatic coupling to direct the pest control material out of the tube and into the area infested with pests.
